(19) United States
(12) Patent Application Publication
(10) Pub. No.: US 2014/0221879 A1
(43) Pub. Date: Aug. 7, 2014

(54) BREAST BUILDING AND WAIST SHAPING DEVICE

(71) Applicant: HUA LING CHU, Taoyuan County (TW)

(72) Inventor: HUA LING CHU, Taoyuan County (TW)

(21) Appl. No.: 13/758,051

(22) Filed: Feb. 4, 2013

(51) Int. Cl. A61H 1/00

(52) U.S. Cl. CPC A61H 1/005
USPC 601/18

(57) ABSTRACT

A breast building and waist shaping device includes a pad body, whereon are disposed a pillow, a breast building unit and a waist shaping unit. The breast building unit includes a base body with two slot parts. A plurality of bulges, malaxating parts, massaging parts and heating parts are disposed in the slot parts. The waist shaping unit includes a slice body whereon are disposed vibrating and heating parts. Binding bands are disposed on two sides of the slice body. A user lies face-down on the pad body with the breast placed in the slot parts of the breast building unit and the binding bands of the waist shaping unit tied around the waist. In this manner, the effects of breast building and waist shaping are achieved through malaxation, vibration, massage and fomentation.

### BACKGROUND OF THE INVENTION

1. Field of the Invention

The present invention relates to a breast building and waist shaping device, particularly to a device which provides the functions of breast building and waist shaping through malaxation, vibration, massage and fomentation.

2. Description of Related Art

It is every woman's dream to have a fit and beautiful body. In the past, only a breast augmentation surgery can help women realize this dream. Seeing that not all women are willing to undergo such a surgery, some manufacturers devise different kinds of auxiliary methods, such as medicine, fitness equipment or breast building device. However, all of these may increase risk of breast cancer without the benefit of effectively building up breast. To build up breast muscles and shape the waist without any undesirable side effects, it is preferable to properly malaxate, vibrate, massage and foment the breast and the waist.

Therefore, a breast building and waist shaping device which provides the functions of breast building and waist shaping through malaxation, vibration, massage and fomentation is substantially required.

### SUMMARY OF THE INVENTION

The primary object of the present disclosure is to offer a breast building and waist shaping device which provides the functions of breast building and waist shaping through malaxation, vibration, massage and fomentation.

To achieve the above purposes, a breast building and waist shaping device is disclosed. The breast building and waist shaping device comprises a pad body, whereon are disposed a pillow, a breast building unit and a waist shaping unit. The breast building unit includes a base body, on which are disposed two slot parts. A plurality of bulges is disposed on the slot parts. Malaxating, massaging and fomenting parts are also disposed on the slot parts. The waist shaping unit includes a slice body, on which are disposed vibrating and fomenting parts. On two sides of the slice body are disposed binding bands. When using this device, a user lies face-down on the pad body with the breast placed in the slot parts of the breast building unit and the binding bands of the waist shaping unit tied around the waist. In this manner, the effects of breast building and waist shaping are achieved through malaxation, vibration, massage and fomentation.

### BRIEF DESCRIPTION OF THE DRAWINGS

FIG. 1 is a three-dimensional drawing of the present invention;

FIG. 2 is a three-dimensional breakdown drawing of the breast building unit of the present invention;

FIG. 3 is a three-dimensional drawing of the breast building unit of the present invention;

FIG. 4 is a three-dimensional drawing of the waist shaping unit of the present invention;

FIG. 5 is a three-dimensional breakdown drawing of the waist shaping unit of the present invention;

FIG. 6 is a structural diagram of the breast building unit of the present invention;

FIG. 7 is an embodiment of the present device in use.

### DETAILED DESCRIPTION OF THE PREFERRED EMBODIMENTS

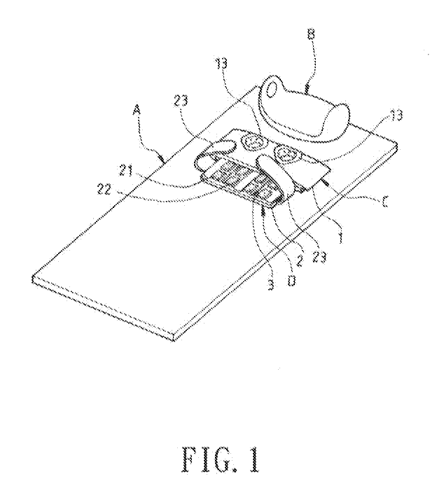

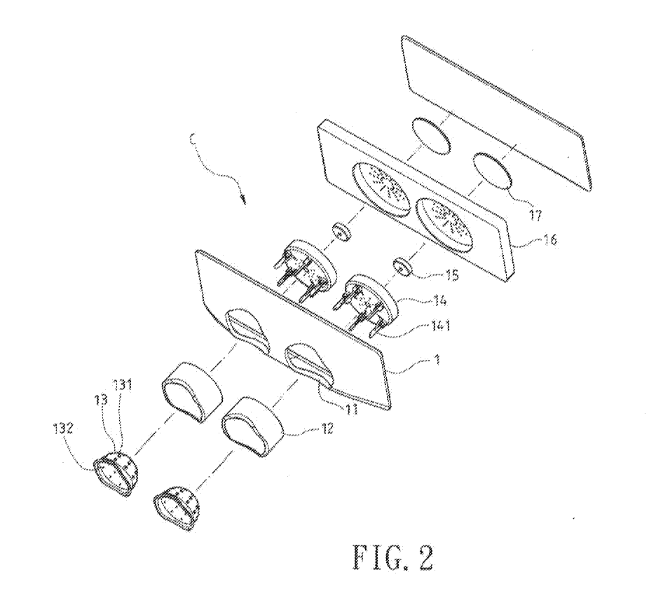

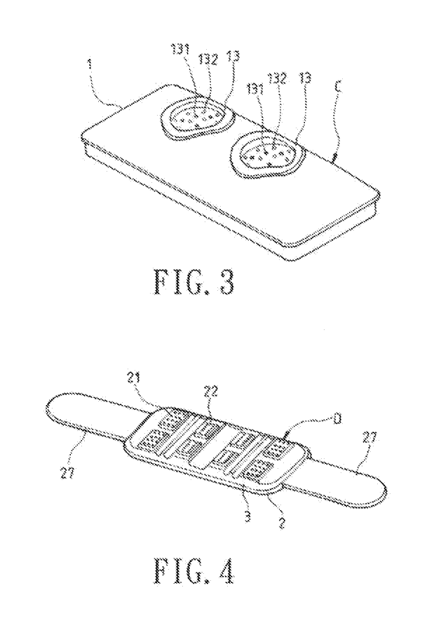

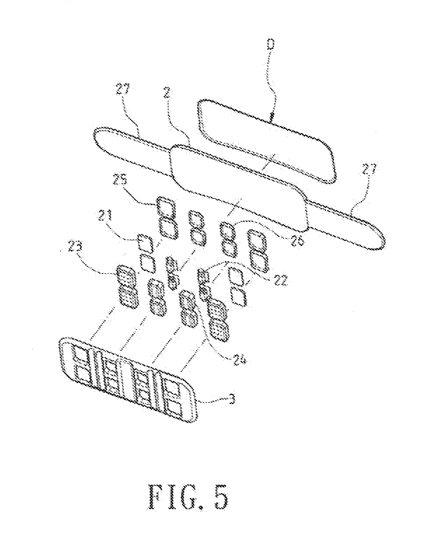

Please refer to FIG. 1 and FIG. 2 along with FIG. 3, FIG. 4 and FIG. 5, showing respectively a three-dimensional drawing of the present invention, a three-dimensional breakdown drawing and a three-dimensional drawing of the breast building unit, and a three-dimensional drawing and a three-dimensional breakdown drawing of the waist shaping unit. As shown in these figures, this invention includes a pad body A, whereon are disposed a pillow B, a breast building unit C and a waist shaping unit D. The breast building unit C includes a base body 1, on which are disposed two slot parts II to hold two centering tubes 12. The two centering tubes 12 holds two round concave cladding bodies 13 made of soft material. A plurality of throughholes 131 and bulges 132 are disposed on the cladding bodies 13. Below the cladding bodies 13 are disposed malaxating parts 14 and vibrating parts 15. The malaxating parts 14 include at least five claw devices 141. The malaxating parts 14 and vibrating parts 15 are placed on a base 16, at a rear of which are disposed heating parts 17.

The waist shaping unit D consists of a slice body 2 and an upper cap 3. A plurality of heating parts 21 and vibrating parts 22 are disposed on the slice body 2. The heating parts 21 and the vibrating parts 22 are placed on retaining bases 23 and 24 and clasped with rear covers 25 and 26. On two sides of the waist shaping unit D are disposed binding bands 27.

The combination of the above-mentioned parts forms a breast building and waist shaping device. A user may lie face-down on the pad body, with the head resting on the pillow B, the breast in the cladding bodies 13 of the slot parts 11 of the breast building unit C, and the binding bands 27 of the waist shaping unit D tied around the waist. The effect of breast building is achieved through malaxation by the claw devices 141 of the malaxating parts 14, massage by the vibrating parts 15 and fomentation by the heating parts 17. The waist shaping unit D achieves the effect of waist shaping through massaging the waist by the vibrating parts 22 and fomentation by the heating parts 21. In this manner, the effects of breast building and waist shaping are achieved by a single device.

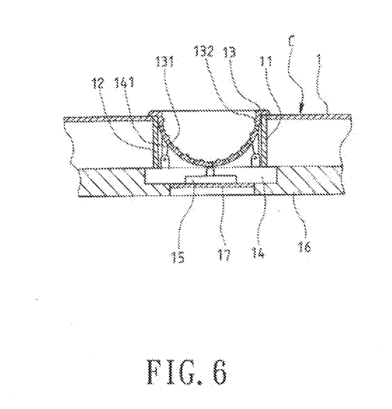

Please refer to FIG. 6, a structural diagram of the breast building unit C of the present invention. As shown in the figure, the breast building unit C of the present invention includes at least round concave cladding bodies 13, malaxating parts 14, vibrating parts 15 and heating parts 17. A plurality of throughholes 131 and bulges 132 are disposed on the cladding bodies 13. When the breast is placed in the cladding bodies 13, the claw devices 141 of the malaxating parts 14 provide malaxation to the breast. The bulges 132 on the cladding bodies 13 further enhance the effect of malaxation. The vibrating parts 15 provide vibrating massage and the heat from the heating parts 17 provide fomentation to the breast via the throughholes 131, both of which increase the effect of breast building.

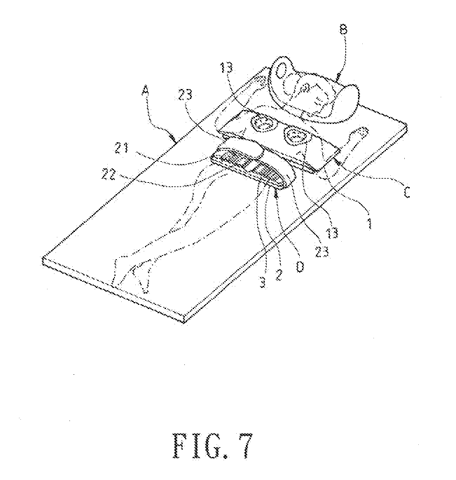

Please refer to FIG. 7, an embodiment of the present invention in use. As shown in the figure, a user lies face-down on the pad body A, with the head resting on the pillow B, the breast in the cladding bodies 13 of the slot parts 11 of the breast building unit C, and the binding hands 27 of the waist shaping unit D tied around the waist. The effect of breast building is achieved through malaxation of the claw devices 141 of the malaxating parts 14, massage of the vibrating parts 15 and fomentation of the heating parts 17. The waist shaping unit D achieves the effect of waist shaping through massaging the waist by the vibrating parts 22 and fomentation by the heating parts 21. In this manner, the effects of breast building and waist shaping are achieved by a single device. In the present embodiment, the operating and control functions include as least:

1. Setting the malaxation strength and angle of the malaxating parts 14 of the breast building unit C to make malaxation more comfortable.

2. Setting the vibration strength and speed of the vibrating parts 15 of the breast building unit C and the temperature of the heating parts 17.

3. Setting the vibration strength and speed of the vibrating parts 22 of the waist shaping unit D and the temperature of the heating parts 21.

Through the above-mentioned setting and control, different units can function under optimal conditions and provide maximum effect of breast building and waist shaping to different users.

What is claimed is:

1. A breast building and waist shaping device, comprising a pad body whereon are disposed a pillow, a breast building unit and a waist shaping unit; wherein the breast building unit includes a base body whereon are disposed two slot parts and on the slot parts are disposed a plurality of bulges, malaxating parts, massaging parts and fomenting parts; wherein the waist shaping unit includes a slice body whereon are disposed vibrating and heating parts and on both sides of the slice body are disposed binding bands; and wherein a user lies face-down on the pad body, with the breast placed in the slot parts of the breast building unit and the binding bands of the waist shaping unit tied around the waist, so as to achieve the effects of breast building and waist shaping through malazation, vibration, massage and fomentation.

2. The breast building and waist shaping device as defined in claim wherein the breast building unit includes a base body whereon are disposed two slot parts to hold two centering tubes which hold two cladding bodies, and wherein malaxating parts, vibrating parts and heating parts are disposed below the cladding bodies.

3. The breast building and waist shaping device as defined in claim 1, wherein the waist shaping unit includes a slice body and an upper cap, wherein on the slice body are disposed a plurality of vibrating parts and heating parts which are placed on retaining bases and clasped with rear covers.
